(19) United States
(12) Patent Application Publication
(10) Pub. No.: US 2024/0269696 A1
(43) Pub. Date: Aug. 15, 2024

(54) RETENTION VALVE FOR A RANGE OF PACKAGING

(71) Applicant: Eric Zembrod, Botucatu (BR)

(72) Inventor: Eric Zembrod, Botucatu (BR)

(21) Appl. No.: 18/568,101

(22) PCT Filed: Jun. 7, 2021
(86) PCT No.: PCT/BR2021/050243

§ 371 Date: Dec. 7, 2023

(51) Int. Cl. B05B 11/00; B65D 83/00

(52) U.S. Cl. CPC B05B 11/0064; B65D 83/00

(57) ABSTRACT

RETENTION VALVE FOR VARIOUS PACKAGES relates to a retention valve for a range of packaging, consisting of a capsular body (1) forming an outlet duct for the product to be dispensed, the outer diameter of which is provided with means (2) for securing to the inside of the outlet in the form of a circular hole (F) of a dispensing pack (E), while its inner diameter slidably accommodates a longitudinally movable obturator (3), and the front end of which has closing means (4) for a obturator (3), while its rear end is flexibly engaged in the centre of a flexible sieve (5) and, at this point, said sieve has means for keeping the aforementioned obturator (3) pulled back in order to keep the leak-tight closing means (4) closed.

### FIELD OF INVENTION

More particularly, the present invention refers to a retention valve suitable for use at the outlet point or outlet spout of the most varied packaging for easy-flowing products, as: cosmetics, pharmaceuticals, foodstuffs, including even lubricants and other chemicals that, for one reason or another, are dispensed in considerably reduced quantities.

On the other hand, the present retention valve is a device developed independently, with means to be simply fitted and locked next to the product outlet, this outlet in the form of a simple hole or in the form of a spout, where its main functions are: close and open the outlet (spout), avoid splashes and prevent air from entering.

### STATE OF THE ART

As is well known, there is currently a considerable variety of packages that, in general terms, include a reservoir, a dispensing head and a suitable exit point for the product. The output can be a simple hole or a more detailed region, including the shape of a spout or dispensing spout. Such details or configurations of the exit point are always present and in similar ways, which does not happen with the dispensing head, as this usually varies considerably depending on the product to be dispensed.

In some cases, pump-like mechanisms are provided, usually in the form of a digital push button and automatic return. However, such pumping can also be represented by a very simple constructive form, which consists of increasing the internal pressure of the container by simply pressing the package itself. Thus, regardless of such aspects, normally the dispensing head or other corresponding part of the packaging, includes various valve systems, all of them designed to open when the dispensing head is activated or when the packaging is pressed, allowing a certain amount of product to flow easily can come out through the dispensing spout of the package. This way of serving a quantity of product is already known and currently there is a range of specific constructions for each case or product.

Currently, it has been a constant concern with regard to the residual part of the dispensed product that is housed between the outlet limit and the internal mechanism that releases the product at each activation. The residual part, although small, remains in an undesirable position, capable of producing splashes and drips, in addition to other more serious inconveniences, particularly with regard to the influences of the external environment, since this residual part is an easy target for the effects produced by the air and ambient humidity, such as: dryness and contamination by the most varied pathogens. As if these inconveniences were not enough, the residual part can undergo other significant alterations, since it is still possible to occur different alterations of the original characteristics of the product or of the formulation itself, mainly oxidation, drying or humidification.

Due to the inconveniences above, the products ended up being prepared with substances to avoid alterations of the same during the use of the packaging. The most used substance is, without a doubt, different types of preservatives, whose amounts are increased to the point that it is sufficient to guarantee the original characteristics of the product until the end of its consumption or until the end of its validity.

Although chemical substances such as preservatives and others are used to guarantee the quality of the product all over the world, several guidelines aim to regulate, control and limit their presence, since they are potentially dangerous for human health, mainly when present, for example, in cosmetic products and drugs and can cause serious allergies.

To solve the above inconveniences and concomitantly reduce the amount of preservatives in different products, the state of the art flourished in the sense of providing means so that the outlet or outlet spot of the product in different packages could include resources to be closed automatically after each activation, thus preventing that residual part from being altered by agents of the external environment, as taught, just as an example, the documents: BR102015016947, EP1264639, US007464839, US7578417, US7934667, US8245884, US8261952, US8328120, US8453875, US8616416, US8678245, US8863994, US8960504, US9038863, US9630768, US20090314810, US20100147898, US20110284579, US20120111898, US20120199119, US20130056500, US20140299679 and US20170233171.

There is no doubt that the state of the art offers valve mechanisms, in the generic form of pistons or even membranes, to eliminate the inconveniences listed above. However, it was observed that each valve component is intimately integrated with the corresponding parts of the dispensing nozzle or at the end of the product outlet, as shown in documents US7578417, US7934667, US8245884 and US8261952, cited here only as an example, where it can be seen that the “valve” is mounted directly at the end of the product outlet and its constructive details are integrated with other constructive details of the outlet or dispensing spout, thus, each valve is specially developed according to the package where it will be used and according to the product to be dispensed, consequently, it becomes difficult to make such valves with a construction standardized so that it is compatible for use in other different packages.

Therefore, it is desirable that the retention valve, which is also a protection valve, present a simplified construction and capable of defining “a standard model” ideal to be used in different packages and different products to be dispensed, detail this not found in the state of the art.

### Objectives of the Invention

As already mentioned, the outlet of the product, whether in the form of a dispensing spout or not, has a predominant detail which is a passage in the form of a circular hole which, in addition to allowing the flow of the product, constitutes a cavity for fitting and mounting the retention valve.

Exploring such a predominant constructive form in the outlet or dispensing spout in conventional packaging, the present invention adopted as its main objective to define a “cylindrical capsule” type retention valve sized to be simply fitted with interference in said passage or circular hole predominantly existing in the outlets or spout of packaging dispenser. Logically, the simple interference fit may or may not include projections or male and female fittings for permanent locking of the aforementioned cartridge valve.

With such construction, the present cartridge valve is capable of being used in different dispensing packages, regardless of the characteristics of the volume to be dispensed in each actuation, thus characterizing a standard model of retention valve that, still, just by varying its sizing, increases its range of application even more, that is, it becomes suitable for dispensing intimate quantities of product or considerably large quantities, consequently, the same retention valve can be used in packaging for different easy-to-flow products, whether they are: cosmetics, pharmaceuticals, foodstuffs, including lubricants and other chemical products that, for one reason or another, are dispensed in varying amounts.

Another objective of the present invention is the realization of a retention valve with a reduced number of mono-material parts and with simple construction and efficient operation.

Another objective of the present invention is to characterize only three components that define the valve itself, all circular, with an external one defined as an intermediate body, an internal one defined as an obturator and a posterior one defined as a flexible support screen. The intermediate body constitutes the obturator guide and its anterior end constitutes a sealing seat, while, at the posterior end, it includes a fitting for the support screen which, in turn, has a dome that configures a flexible sector or spring for said obturator which, for that, initially, it takes the form of a finned rod, with the anterior end in the form of a sealing head with a truncated shape that fits into that sealing seat, while at the opposite end said rod has a cylindrical extension that, after freely crossing a central hole in the flexible sector, ends in an enlarged point that is supported against the said flexible sector.

Thus assembled, this valve is simply fitted and fixed in the product outlet hole or in the dispenser nozzle hole, where it is maintained for automatic operation, that is, when internal pressure occurs, the product flow finds this valve at the dispenser outlet. When passing through the valve, the internal pressure caused by the product causes the obturator to be displaced in the same direction and, with that, the obturator sealing head moves away from the seal seat, allowing the product to exit until the moment the internal pressure ceases to exist. At this moment, the obturator returns to its original position, thanks to the spring of the sieve whose elastic memory pulls the said obturator backwards to its original sealed position, that is, until its sealing head is seated in the sealing seat, closing completely exiting the product, where the residual part remains completely protected from the external environment, avoiding splashes, oxidation and all sorts of alterations that the environment may cause.

So all the drawbacks mentioned above are completely eliminated, that is, this valve prevents splashes and drips, as well as influences from the external environment, preventing the residual part of the product from being an easy target of the effects produced by the air and ambient humidity, such as: drying and contamination by the most varied pathogens, and also avoids changes in the original characteristics of the product or the formulation itself, mainly oxidation, drying or humidification.

Finally, the valve in question, as already mentioned, presents constructive characteristics that make it “standard”, that is, the valve itself is housed in a cylindrical capsular body, which makes it possible to insert and fix it in the circular outlet of different dispensing packaging for easy-flowing products, whether they are: cosmetics, pharmaceuticals, foodstuffs, including lubricants and other chemical products that, for one reason or another, are dispensed in specific quantities.

### DESCRIPTION OF DRAWINGS

For a better understanding of the present invention, a detailed description of the same is given below, making reference to the attached drawings:

FIG. 1 represents a perspective view of the assembled valve;

FIG. 2 shows another perspective of the assembled valve, however, at a posterior angle;

FIG. 3 illustrates an exploded perspective in front angle showing the details of each component of the valve;

FIG. 4 is also an exploded perspective, however, in a posterior angle showing other constructive details of each component of the valve;

FIG. 5 shows the “A-A” section indicated in FIG. 1, showing the valve completely assembled and fitted in the circular outlet of a usual dispenser package; and the

FIG. 6 represents a view of the same section illustrated in the previous figure, however, in this case the valve is schematically shown in the open position.

### DETAILED DESCRIPTION OF THE INVENTION

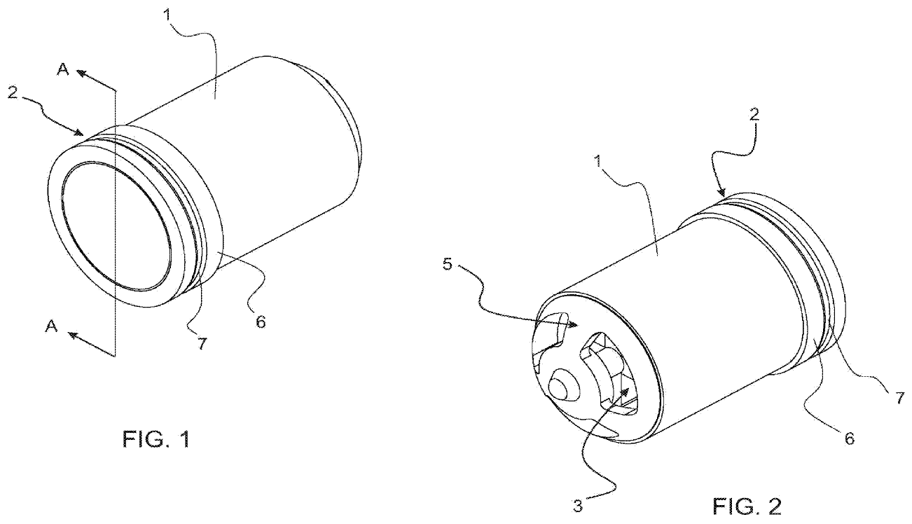

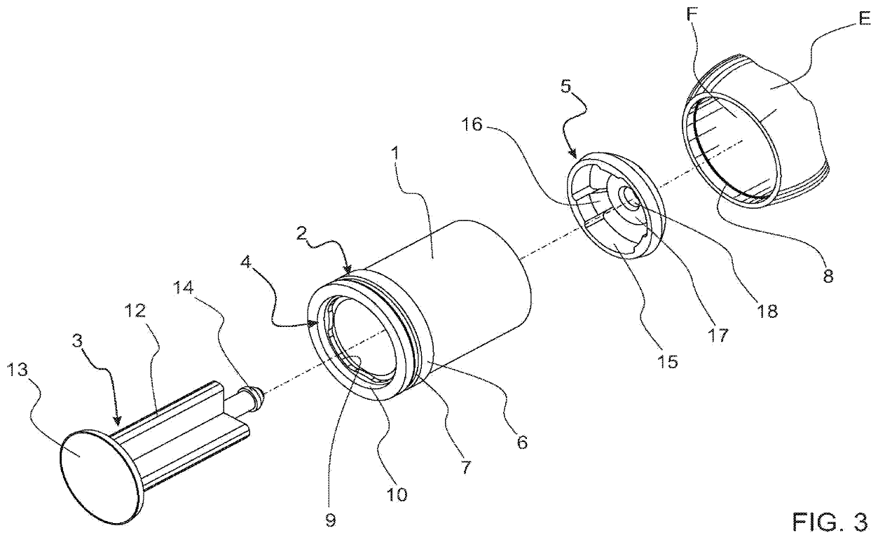

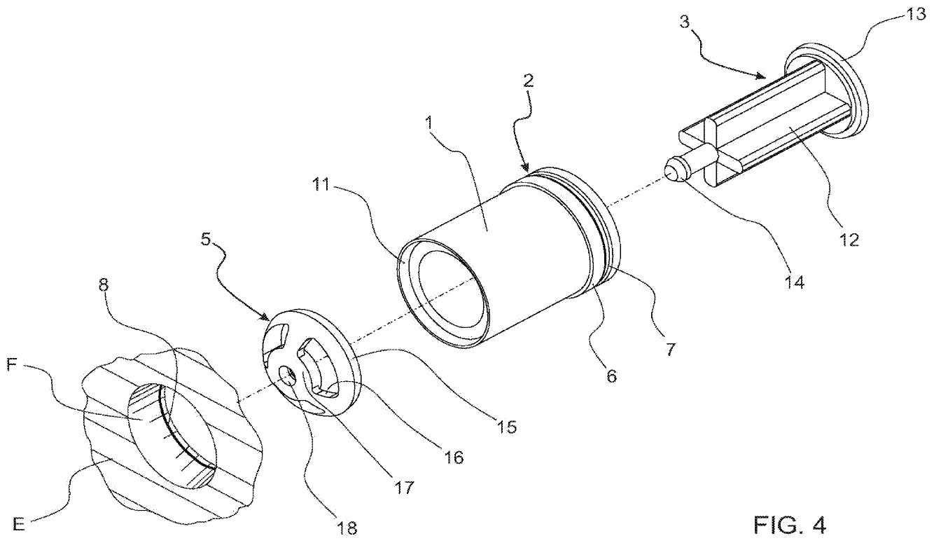

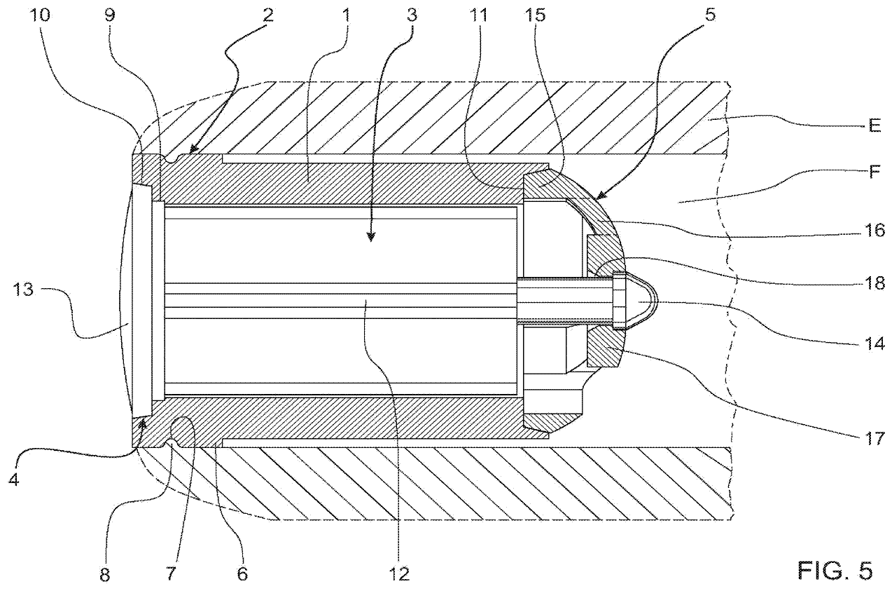

According to these figures and their details, more particularly FIGS. 1 to 5, the present invention, RETENTION VALVE FOR VARIOUS PACKAGES, is characterized by comprising a capsular body (1), which configures an outlet conduit for the product to be dispensed, this body having an external diameter, equipped with means (2) of fixation internally to the exit in the form of a circular hole (F) of a usual dispensing package (E), while in its internal diameter is housed, slidingly, an obturator (3) movable longitudinally, as well as its front end has means (4) of watertight sealing for the obturator (3), while its rear end is softly engaged in the center of a flexible sieve (5) and, at this point, said sieve has means to keep said obturator (3) tensioned backwards in order to keep the closed the means (4) watertight, where the closing pressure is overcome by the internal pressure established inside the outlet in the form of a circular hole (F) when activating the usual dispensing package (E).

In a preferred construction, the fastening means (2) inside the outlet in the form of a circular hole (F) of a usual dispenser package (E) are formed by a circular collar (6) with a central groove (7) for engagement in a circular fillet (8) existing in said outlet in the form of a circular hole (F), and this fixation can also be carried out by simple mechanical interference.

The capsular body (1) has the ends of its internal diameter defined by staggered sections, in which the anterior one that defines the sealing means (4) has two steps, both greater than 90°, an internal one (9) and an external one that configure the cone-shaped sealing seat (10) for seating the corresponding part of the obturator (3), while at the opposite end of said capsular body (1) there is another step at an angle greater than 90° (11) for seating the flexible sieve (5).

The obturator (3), in a single piece, comprises an intermediate section longitudinally finned (12), a front head in the form of a bung (13) and a posterior cylindrical tip with a coupling terminal (14), in which the longitudinally finned intermediate section (12) is slidably adjusted to the internal diameter of the capsular body (1), while its front head in the form of a bung (13) has the shape of a circular tablet with a truncated external diameter that rests on the conical sealing seat (10) of the capsular body (1), and also the posterior tip of the coupling terminal (14) of the obturator (3) constitutes irreversible engagement in the spring center of the flexible sieve (5).

The flexible sieve (5) is defined by an annular section (15), whose external diameter is conical cooperating for seating on the step (11) of the capsular body (1), and the posterior side of the annular section (15) is extended in the form hollow dome defined by flexible links (16) that culminate in a circular center (17) with a penetration hole (18) with interference from the rear coupling tip (14) of the obturator (3).

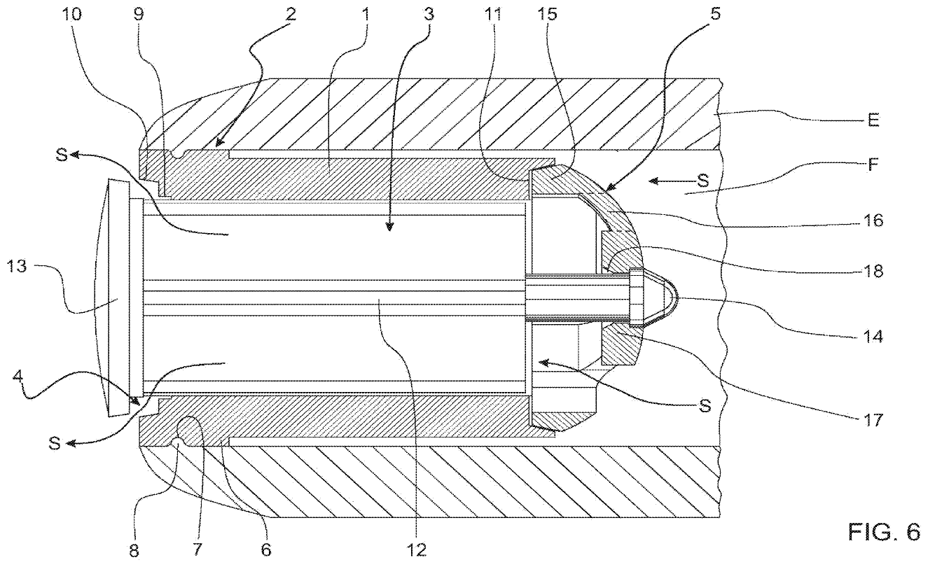

With regard to FIG. 6, the assembly and operation of the present retention valve are substantially simple, that is, the assembly takes place with just the insertion of the set in the outlet or outlet hole (F) of the product to be ejected by the usual dispenser (E). In this condition, when there is internal pressure (as indicated by the arrows) at the outlet (F) the product begins to flow towards the sieve (5) and runs through the entire interior of the valve, however, when it encounters the bung (13) this pressure forces the bung (13) out. At this moment, two simultaneous effects occur, since the links (16) of the sieve (5) are flexed inwards and with it the obturator (3) is moved in the same direction, causing the bung (13) to move away from its seat of seal (4) and thus, as indicated by the arrows (S), the product flows out in a controlled manner while there is internal pressure at the outlet (F) of the dispensing pack (E). The product only stops flowing out when the internal pressure is lower than the flexibility strength of the sieve (5), that is, when the internal pressure is lower or ceases to exist, the obturator (3) returns to its original position, thanks to the spring of the sieve whose elastic memory pulls the said obturator even backwards to its original watertight position, completely closing the product outlet, where the residual part remains totally protected from the external environment.

1. RETENTION VALVE FOR VARIOUS PACKAGES, characterized in that it comprises a capsular body (1), which configures an outlet conduit for the product to be dispensed, this body having an external diameter, equipped with means (2) for fastening inside the outlet in the form of a circular hole (F) of a usual dispensing package (E), while its internal diameter is housed, slidably, a obturator (3) movable longitudinally, as well as its front end has means (4) of watertight sealing for the obturator (3), while its rear end is softly engaged in the center of a flexible sieve (5) and, at this point, said sieve has means to keep said obturator (3) tensioned backwards in order to keep the means (4) closed watertight, where the closing pressure is overcome by the internal pressure established inside the outlet in the form of a circular hole (F) when activating the usual dispensing package (E).

2. RETENTION VALVE FOR VARIOUS PACKAGES, according to claim 1, characterized in that, in a preferred construction, the means (2) of fastening inside the outlet in the form of a circular hole (F) of a usual dispensing package (E) is carried out by mechanical interference.

3. RETENTION VALVE FOR VARIOUS PACKAGES, according to claim 2, characterized by the means (2) of fixation by mechanical interference in the inside the outlet in the form of a circular hole (F) of a usual dispenser package (E) are formed by a circular collar (6) with a central groove (7) for engagement in a circular fillet (8) existing in said outlet in the form of a circular hole (F).

4. RETENTION VALVE FOR VARIOUS PACKAGES, according to claim 1, characterized in that the capsular body (1) has the ends of its internal diameter defined by staggered sections, in which the anterior one that defines the sealing means (4) has two steps, both greater than 90°, one internal (9) and one external that configure the cone shaped sealing seat (10) for seating the corresponding part of the obturator (3), while at the opposite end of said capsular body (1) there is another step at an angle greater than 90° (11) for laying the flexible sieve (5).

5. RETENTION VALVE FOR VARIOUS PACKAGES, according to claim 1, characterized in that the obturator (3), in a single piece, comprises an intermediate section longitudinally finned (12), a front head in the form of a bung (13) and a posterior cylindrical tip with coupling terminal (14), in which the longitudinally finned intermediate section (12) is slidably adjusted to the internal diameter of the capsular body (1), while its front head in the form of a bung (13) has the shape of a circular tablet with a truncated external diameter that rests on the conical sealing seat (10) of the capsular body (1), being that, furthermore, the posterior tip of the coupling terminal (14) of the obturator (3) constitutes irreversible engagement in the spring center of the flexible sieve (5).

6. RETENTION VALVE FOR VARIOUS PACKAGES, according to claim 1, characterized in that the flexible sieve (5) comprises an annular section (15), whose external diameter is conical for seating on the step (11) of the capsular body (1), whereby the posterior side of the annular section (15) is extended in the form of a hollow dome defined by flexible links (16) that culminate in a circular center (17) with a penetration hole (18) with interference from the rear coupling tip (14) of the obturator (3).
